(19) United States
(12) Patent Application Publication
(10) Pub. No.: US 2010/0192098 A1
(43) Pub. Date: Jul. 29, 2010

(54) ACCELERATORS FOR CAPTURING CONTENT

(75) Inventors: Jane T. Kim, Seattle, WA (US); Miladin Pavlicic, Sammamish, WA (US); Dave Risney, Kirkland, WA (US); Jonathan W. Seitel, Kirkland, WA (US); Michael Benny, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/362,314

(22) Filed: Jan. 29, 2009

(51) Int. Cl. G06F 3/048

(52) U.S. Cl. 715/827

(57) ABSTRACT

Various embodiments can provide a convenient way of sending selected online content to one or more applications, such as an application running on a local machine, a web application, a web service, and so on. In at least some embodiments, one or more accelerators can be presented to a user based at least in part on a user having selected content and the nature of the content that the user has selected. An accelerator can serve as a pipeline that can send the selected content to one or more applications. A variety of different accelerators can be utilized, and each accelerator can be suited to handle a particular type or types of content. A user can select a particular accelerator, which can cause an application associated with the accelerator to be launched and selected content to be provided to the application.

### BACKGROUND

A large amount of content, such as text, pictures, audio, and video content, can be accessed online (e.g., via the Internet). A user may encounter online content that the user wants to capture and manipulate using a particular application. Current ways of capturing online content and providing the captured content to an application can be cumbersome, however. For example, a user may encounter a news article that the user wishes to email to a friend. One way of accomplishing this is to select the text of the article, copy the text, launch an email application, open a new email document, and paste the text into the email document. This process is complicated and can lead to user frustration. Also, some content may not be suitable for processing or manipulation by a particular application. An attempt by a user to provide such content to the particular application may result in poor application performance, loss of content integrity, or other undesirable scenarios.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments can provide a convenient way of sending selected online content to one or more applications, such as an application running on a local machine, a web application, a web service, and so on. In at least some embodiments, one or more accelerators can be presented to a user based at least in part on a user having selected content and/or the nature of the content that the user has selected. An accelerator can serve as a pipeline that can send the selected content to one or more applications. A variety of different accelerators can be utilized, and each accelerator can be suited to handle a particular type or types of content. A user can select a particular accelerator, which can cause an application associated with the accelerator to be launched and selected content to be provided to the application.

### BRIEF DESCRIPTION OF THE DRAWINGS

The same numbers are used throughout the drawings to reference like features.

FIG. 1 illustrates an operating environment in which the inventive principles can be employed in accordance with one or more embodiments.

FIG. 2 illustrates an example Web browser user interface in accordance with one or more embodiments.

FIG. 3 illustrates example user interfaces in accordance with one or more embodiments.

FIG. 4 illustrates example user interfaces in accordance with one or more embodiments.

FIG. 5 is a flow diagram that describes steps in a method in accordance with one or more embodiments.

FIG. 6 is a flow diagram that describes steps in a method in accordance with one or more embodiments.

FIG. 7 is a flow diagram that describes steps in a method in accordance with one or more embodiments.

FIG. 8 is a flow diagram that describes steps in a method in accordance with one or more embodiments.

FIG. 9 is a block diagram of a system in accordance with one or more embodiments.

### DETAILED DESCRIPTION

Overview

Various embodiments can provide a convenient way of sending selected online content to one or more applications, such as an application running on a local machine, a web application, a web service, and so on. In at least some embodiments, one or more accelerators can be presented to a user based at least in part on a user having selected content and/or the nature of the content that the user has selected. An accelerator can serve as a pipeline that can send the selected content to one or more applications. A variety of different accelerators can be utilized, and each accelerator can be suited to handle a particular type or types of content. A user can select a particular accelerator, which can cause the accelerator to receive and/or capture the selected content. The selected accelerator can cause an application associated with the accelerator to be launched, and the selected content to be provided to the application.

In at least some embodiments, an accelerator can inspect selected content to determine if the content may be relevant to a particular application. For example, a particular accelerator may be associated with a video editor. In a scenario where a user selects text content, the accelerator may determine that text content has been selected and that the text content may not be relevant to the video editor. If an accelerator determines that selected content may not be relevant to an application associated with the accelerator, the option of selecting the accelerator may not be presented to a user. Alternatively, if an accelerator determines that selected content may not be relevant to an application associated with the accelerator, the option to select the accelerator may be presented to the user with less emphasis than another accelerator for which the selected content may be more relevant.

In at least some embodiments, an accelerator can cause a content preview to be presented. The content preview can display a representation of the selected content as it can appear if the selected content were to be sent to a particular application. For example, a user can select an image (e.g., a JPEG file), and a preview of the image as it can appear on an image editor interface can be presented without immediately launching an image editor application.

In the discussion that follows, a section entitled “Operating Environment” describes but one environment in which the various embodiments can be employed. Following this, a section entitled “Example User Interfaces” describes example user interfaces in accordance with one or more embodiments. Next, a section entitled “Example Methods” describes example methods in accordance with one or more embodiments. Last, a section entitled “Example System” is provided and describes an example system that can be used to implement one or more embodiments.

Operating Environment

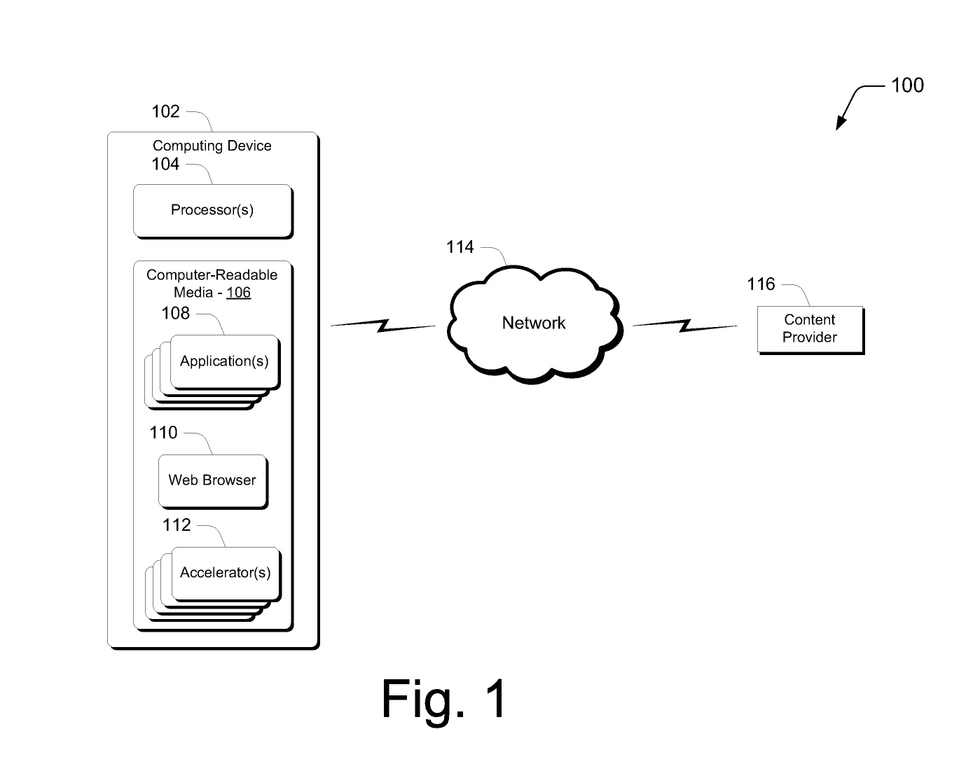

FIG. 1 illustrates an operating environment in accordance with one or more embodiments, generally at 100. Environment 100 includes a computing device 102 having one or more processors 104, one or more computer-readable storage media 106 and one or more applications 108 that reside on the computer-readable storage media and which are executable by the processor(s). Applications 108 can include any suitable type of application such as, by way of example and not limitation, word processing applications, search applications, e-mail applications, instant messaging applications, graphics editors, and a variety of other applications. Applications 108 can also include one or more web-based applications, such as a blogging service, a map service, a web development service, and so on. Computing device 102 also includes a web browser 110 and one or more accelerators 112. Web browser 110 can be implemented to access online content, such as via the Internet and so on.

Accelerators 112 can be configured to receive content from the web browser 110 (e.g., content that is selected by a user), inspect the content, and/or to send content to one or more of the applications 108. In at least some embodiments, one or more of the accelerators 112 can be implemented as a component object model (COM) object that is configured to recognize certain types of content and/or content formatting. In an example implementation, the accelerators 112 can be loaded with the web browser 110 when the web browser is launched. When content is selected via the web browser 110, the web browser can make the selected content available to the accelerators 112. The accelerators 112 can inspect the selected content to determine if the selected content is relevant to a particular accelerator and/or an application associated with the accelerator.

For purposes of illustration, consider an example in which one of the accelerators is an audio accelerator that is configured to handle audio content and is associated with an audio editor application. In this example, if the audio accelerator were to receive selected video content, the audio accelerator can determine that the selected video content is in a format that the audio accelerator and/or the audio editor application is not configured to handle. Thus, the selected video content may not be relevant to the audio accelerator and/or the audio editor application. In one or more embodiments, the accelerators 112 can notify web browser 110 concerning the relevance of selected content to the accelerators and/or an application associated with the accelerators (e.g., one of applications 108).

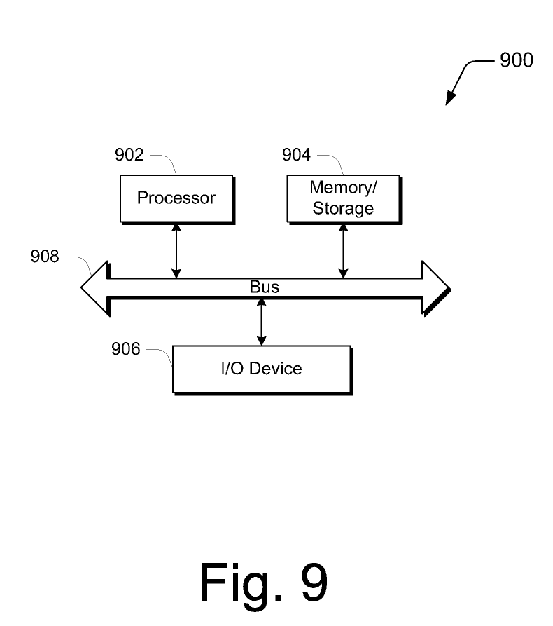

The computer-readable storage media 106 can include, by way of example and not limitation, all forms of volatile and non-volatile memory and/or storage media that are typically associated with a computing device. Such media can include ROM, RAM, flash memory, hard disk, removable media and the like. One specific example of a computing device is shown and described below in FIG. 9.

In addition, environment 100 includes a network 114, such as the Internet, and one or more content providers 116. Examples of content providers 116 include a website, a web log (“blog”), a file sharing site, a social networking site, or any other resource through which content can be accessed. In at least some embodiments, computing device 102 can be utilized to access the one or more content providers 116 via the network 114.

Computing device 102 can be embodied as any suitable computing device such as, by way of example and not limitation, a desktop computer, a portable computer, a handheld computer such as a personal digital assistant (PDA), cell phone, and the like.

Having considered an example operating environment, consider now a discussion of example user interfaces for implementing one or more accelerators to capture content. The example user interfaces are discussed with reference to environment 100 above.

Example User Interfaces

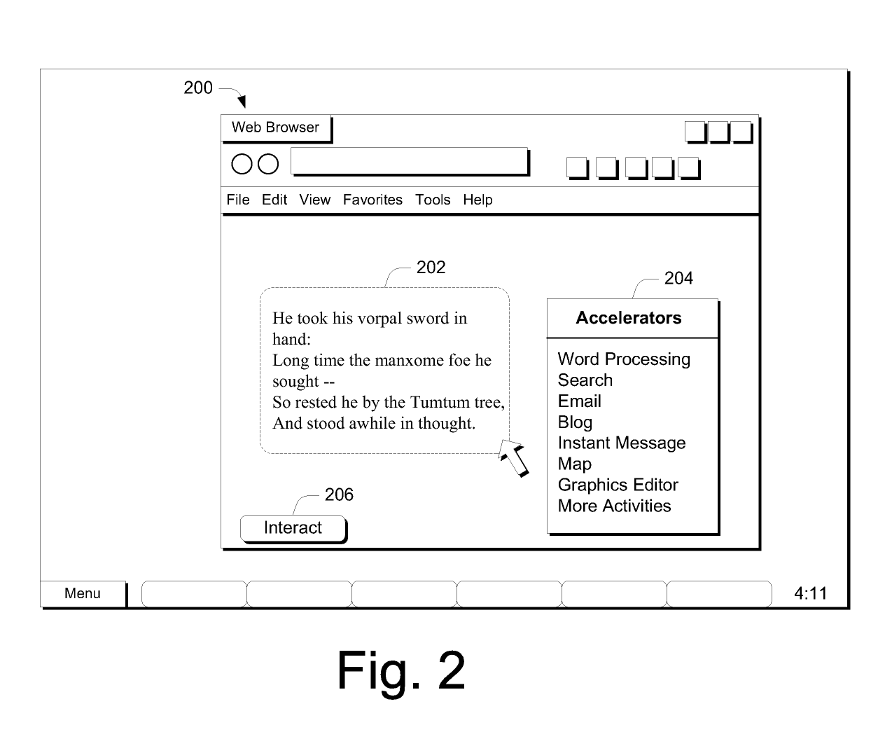

FIG. 2 illustrates an example Web browser user interface generally at 200 in accordance with one or more embodiments. For purposes of this example, assume that a user has navigated to a website's web page via a web browser, and the web page is displayed as part of web browser user interface 200. In one or more embodiments, a user can select content on the web page using one or more of a variety of content selection methods. For example, a user can utilize a mouse and pointer to click on and select content. In this example, content 202 has been selected, and content 202 includes a section of text. Responsive to the selection of content 202, an accelerators menu 204 can be displayed. Alternatively and/or additionally, when content 202 is selected, an interact icon 206 can be selected. Selecting the interact icon 206 can cause the accelerators menu 204 to be displayed. Thus, according to one or more embodiments, the accelerators menu 204 can be displayed automatically responsive to content being selected, and/or responsive to the interact icon 206 being selected.

The accelerators menu 204 can list a variety of accelerator icons that represent one or more accelerators that are available. In this example, accelerators menu 204 includes accelerator icons for word processing, search, email, blogging, instant messaging, mapping, graphics editing, and so on. In this example, the accelerators menu 204 also includes a “more activities” option that can be selected to retrieve one or more options that may be available, e.g., one or more additional accelerators. According to one or more embodiments, when content 202 is selected, the web browser can query one or more accelerators with the content 202 and/or information about the content 202. Information about the content 202 can include metadata about the content, formatting information about the content (e.g., a file type), markup associated with the content (e.g., a tag and/or a markup declaration), and so on. An accelerator that is queried with the content 202 and/or the information about the content can inspect the content and/or information about the content to determine if the content 202 is relevant to the accelerator and/or an application associated with the accelerator. The accelerator can return an indication of the relevance of the content 202 to the web browser and/or other application that handles the accelerators menu 204.

According to one or more embodiments, the display of a particular accelerator icon in the accelerators menu 204 can be based at least in part on the relevance of the content 202 to the particular accelerator represented by the accelerator icon and/or an application associated with the particular accelerator. For example, if the particular accelerator indicates that the content 202 is relevant to the accelerator and/or an associated application, a representative accelerator icon can be emphasized in the accelerators menu 204. Emphasizing an accelerator icon can include displaying the accelerator icon at a higher position in the list of accelerator icons, displaying the accelerator icon in a larger font than other accelerator icons, bolding the accelerator icon, animating the accelerator icon text, and so on. Conversely, if the particular accelerator indicates that the content 202 is less relevant or not relevant, an associated accelerator icon may be displayed with less emphasis than other accelerator icons (e.g., lower on the list of accelerator icons, in a smaller font, and so on), or not displayed at all.

According to one or more embodiments, a particular accelerator can assign a relevance value to a particular instance of selected content. Ways of determining a relevance value are discussed below. Using the relevance values for a particular group of accelerators, the list of accelerator icons displayed in the accelerators menu 204 can be displayed in order of descending relevance values, with an accelerator icon that represents an accelerator with the highest relevance value being displayed at the top of the list. For example, the word processing accelerator may have returned the highest relevance value, and thus the word processing accelerator icon is placed at the top of the list in the accelerators menu 204. The remaining accelerator icons in the list can be associated with accelerators with lesser relevance values, and thus are listed below the word processor accelerator icon.

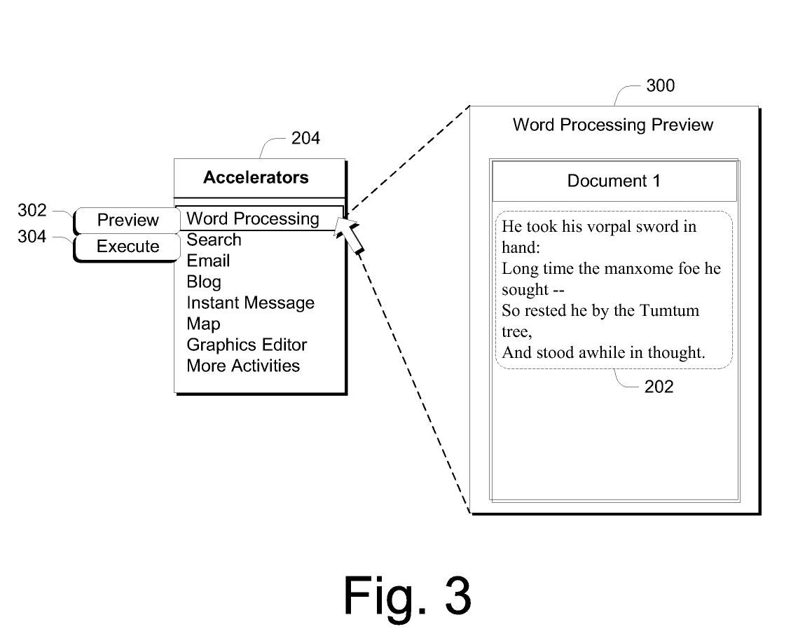

FIG. 3 illustrates an example implementation of the accelerators menu 204 and a preview window 300. FIG. 3 is discussed with reference to the web browser user interface 200, discussed above. According to some embodiments, when content is selected (e.g., content 202) and the accelerators menu 204 is displayed, a user can navigate among the accelerator icons included in the accelerators menu. For example, a user can utilize a mouse and/or keys on a keyboard to move a cursor over the accelerator icons. In one or more embodiments, when a cursor hovers over a particular accelerator icon and/or a particular accelerator icon is selected (e.g., via a mouse click), a preview button 302 and/or an execute button 304 can be displayed. Hovering a cursor over and/or selecting the preview button 302 can cause the preview window 300 to be displayed. Alternatively and/or additionally, the preview window 300 can be displayed when an accelerator icon is selected and/or a cursor hovers over the accelerator icon.

In at least some embodiments, the preview window 300 is configured to display a preview of content that is selected. According to some embodiments, a preview window can display a preview of the selected content as the selected content can appear if the selected content were sent to a particular application associated with an accelerator that is in focus. In this example, a cursor is hovering over the word processing accelerator icon, and thus the word processing accelerator is in focus. The preview window 300 displays a preview of the content 202 as the content can appear if the content were sent to a word processing application associated with the word processing accelerator. In this example, the content 202 is displayed as it can appear as part of a word processing document. According to some embodiments, the preview window 300 can be generated by the word processing accelerator that is in focus. Thus, at least in some embodiments, one or more accelerators can provide their own preview experiences for selected content. For example, an accelerator can include code that generates a preview of selected content. Alternatively and/or additionally, an accelerator can navigate to a particular uniform resource locator (URL) and submit the selected content to a resource located at the URL (e.g., a website). The resource located at the URL can generate all or part of the preview window 300.

According to some embodiments, the execute button 304 can be selected to send selected content to a particular application. In this example, the execute button 304 can be displayed when the word processing accelerator icon is in focus. Selecting the execute button 304 can cause the selected content (e.g., content 202) to be sent to an application (e.g., a word processing application) associated with the word processing accelerator. In at least some embodiments, an application can be launched and selected content sent to the application responsive to the execute button 304 being selected. While the execute button 304 is illustrated in this example as separate from the preview window 300, this is not intended to be limiting, and one or more embodiments can configure the execute button 304 to be displayed elsewhere, such as part of the preview window 300. Alternatively and/or additionally, an application can be launched and/or selected content sent to the application by simply selecting (e.g., clicking on) the preview window 300.

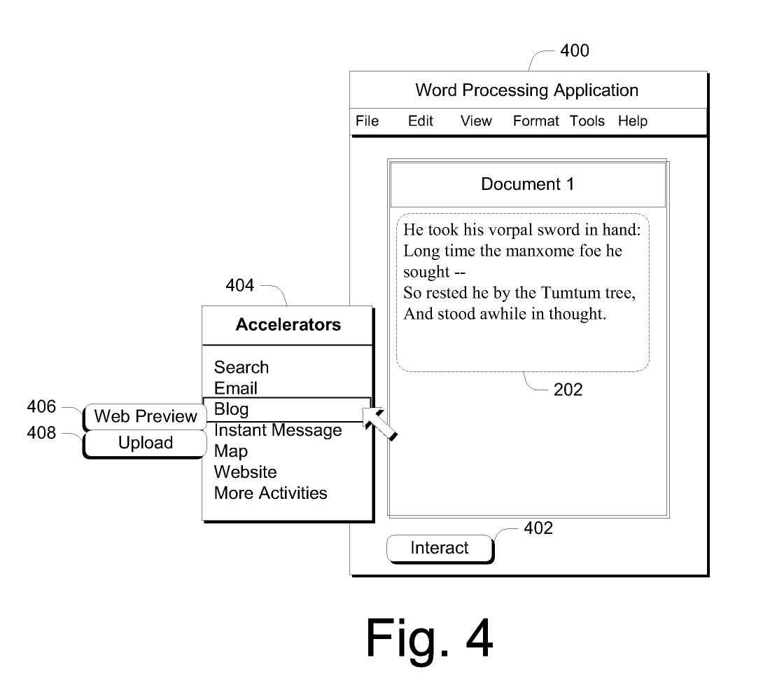

FIG. 4 illustrates an example application user interface that can be implemented with one or more accelerators to upload selected content, generally at 400. In at least some embodiments, the application user interface 400 can be displayed in response to the content 202 being selected and an application being launched, an example of which is discussed above. In an example implementation, a user can select the content 202 and select the interact button 402 to cause the accelerators menu 404 to be displayed. Alternatively and/or additionally, the accelerators menu 404 can be displayed automatically and responsive to the content 202 being selected. As discussed above, the accelerators menu 404 can include accelerator icons that are displayed according to the relevance of the selected content to one or more accelerators.

In at least some embodiments, one or more of the accelerator icons displayed as part of the accelerators menu 404 can be associated with an internet-based web service, such as a blog, a website, a file sharing site, and so on. Thus, when a user navigates to an accelerator icon associated with a web service, a web preview button 406 and/or an upload button 408 can be displayed. If selected, the web preview button 406 can cause a preview to be displayed that presents content 202 as it can appear if the selected content were uploaded to a web service associated with a particular accelerator. In this example, the blog accelerator icon is in focus, and thus a preview of the content 202 can be presented as the content can appear as part of a blog post.

In one or more embodiments, the upload button 408 can be selected to upload the content 202 to a web service. In this example, the content 202 can be uploaded to a blog site by selecting the upload button 408. One or more web services can be registered (e.g., via a URL) with a particular accelerator, thus providing the accelerator with a resource destination for selected content.

Having described an example user interface in accordance with one or more embodiments, consider now a discussion of some example methods in accordance with one or more embodiments.

Example Methods

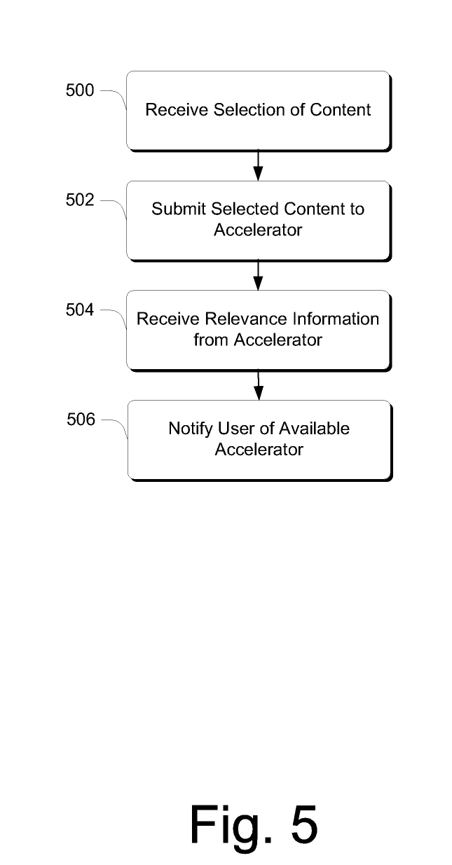

FIG. 5 is a flow diagram that describes a method in accordance with one or more embodiments. The method can be implemented in any suitable hardware, software, firmware, or combination thereof. In at least some embodiments, the method can be implemented by software executing or executable by an application (e.g., a web browser) to display selectable content to a user.

Step 500 receives a selection of content. For example, content that is displayed as part of a web browser interface can be selected by a user. Step 502 submits the selected content to one or more accelerators. In at least some embodiments, this step can occur in response to user input, such as the selection of the interact icon 206, discussed above. According to some embodiments, an accelerator can receive the selected content and evaluate the content for relevance to the accelerator and/or an application associated with the accelerator. Step 504 receives relevance information from one or more accelerators. Relevance information can describe the relevance of the selected content to an accelerator and/or an application associated with the accelerator. Step 506 notifies a user of one or more accelerators that are available. In at least some embodiments, a user can be notified of the one or more accelerators via an accelerators menu being displayed. The accelerators menu can list the available accelerators according to the relevance of the selected content to the available accelerators.

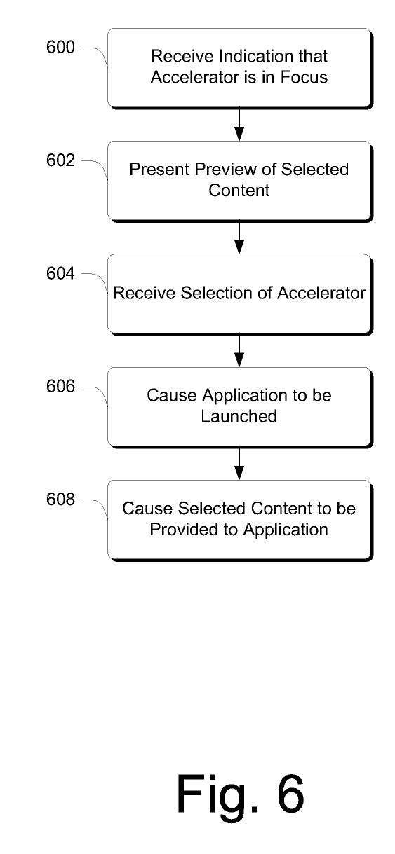

FIG. 6 is a flow diagram that describes a method in accordance with one or more embodiments. The method can be implemented in any suitable hardware, software, firmware, or combination thereof. In at least some embodiments, the method can be implemented by an accelerator.

Step 600 receives an indication that an accelerator is in focus. For example, a user can cause a pointer or other cursor to hover over an accelerator icon associated with the accelerator, indicating that the accelerator is in focus. Step 602 presents a preview of selected content. For example, a window can be displayed that includes a visual preview of the selected content as the selected content can appear if the selected content is sent to an application associated with the accelerator in focus. Step 604 receives a selection of the accelerator. In an example implementation, the selection of the accelerator can occur via a user clicking on an accelerator icon using a mouse and cursor.

Step 606 causes an application to be launched. In at least some embodiments, the application is launched responsive to the accelerator being selected. According to one or more embodiments, an application can be launched using an asynchronous pluggable protocol (APP). An APP can be implemented to create a pluggable protocol handler and/or a namespace handler that can be utilized to associate a URL with a particular application. The URL can be used (e.g., by a web browser) to launch an application identified by the URL. Step 608 causes the selected content to be provided to the application. According to one or more embodiments, the selected content is sent to the application responsive to the accelerator being selected and/or the application being launched.

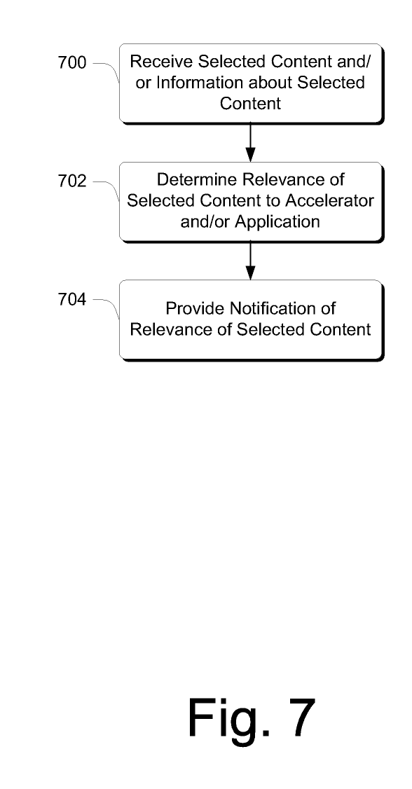

FIG. 7 is a flow diagram that describes a method in accordance with one or more embodiments. The method can be implemented in any suitable hardware, software, firmware, or combination thereof. In at least some embodiments, the method can be implemented by an accelerator.

Step 700 receives selected content and/or information about the selected content. In at least some embodiments, this step can occur responsive to content being selected. For example, a web browser can receive user selection of content displayed in a web browser interface, and the web browser can automatically forward the selected content and/or information about the selected content to one or more accelerators. Step 702 determines the relevance of the selected content to an accelerator and/or an application associated with the accelerator.

As discussed above, determining the relevance of selected content can include assigning a relevance value to the selected content. A relevance value can be calculated using one or more of a variety of techniques. For example, a numeric relevance value can be calculated by assigning a numeric value to each of one or more relevance factors and inspecting selected content based on the one or more relevance factors. Example relevance factors can include the content type of the selected content, such as text, graphics, video, audio, and so on. In one or more embodiments, the content type can be determined by programming code associated with the content and/or a file extension associated with the content (e.g., .txt, .gif, .mpeg, and so on). Relevance factors can also include the size of the selected content, such as the amount of memory required to store and/or process the selected content. Relevance factors can also include information about the selected content, such as metadata and/or markup associated with the selected content. According to one or more embodiments, an accelerator can assign a value to one or more relevance factors associated with the accelerator. The numeric values for a set of relevance factors for a particular instance of selected content can be totaled to determine a relevance value of the selected content. Thus, each accelerator in a particular group of accelerators can be configured to consider a unique set of relevance factors, and the values assigned to one or more of the set of relevance factors can be specific to a particular accelerator.

Step 704 provides a notification of the relevance of the selected content. According to one or more embodiments, an accelerator can provide a relevance value for selected content to a web browser. A menu of available accelerators can be displayed and accelerator icons can be arranged within the menu based at least in part on the relevance values provided by one or more accelerators.

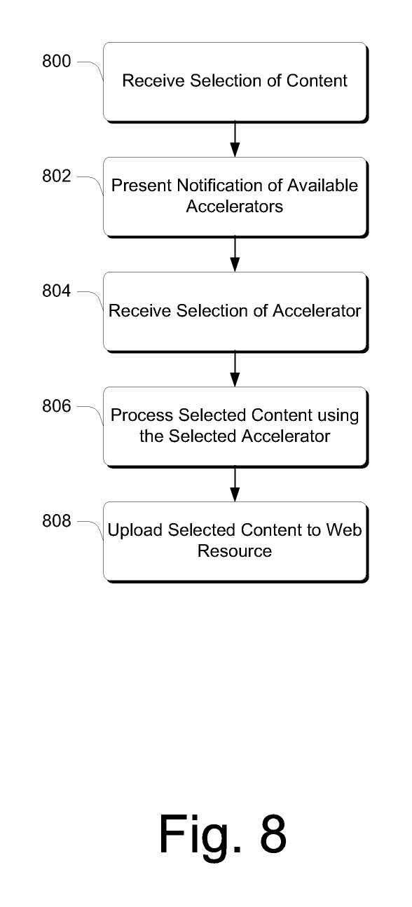

FIG. 8 is a flow diagram that describes a method in accordance with one or more embodiments. The method can be implemented in any suitable hardware, software, firmware, or combination thereof. In at least some embodiments, the method can be implemented by software executing or executable by an application (e.g., a web browser) and/or an accelerator.

Step 800 receives a selection of content. In some embodiments, the content can be selected from an application running on a local device, e.g., a desktop computer. Step 802 presents a notification of accelerators that are available to handle the selected content. The notification can include an accelerators menu, examples of which are discussed above. According to one or more embodiments, the notification can be presented responsive to the content being selected and/or responsive to the selection of a particular button or icon, such as the interact button 402, discussed above.

Step 804 receives a selection of an accelerator. Example ways that an accelerator can be selected are discussed above. According to one or more embodiments, an accelerator that is selected can be associated with a web resource and can enable the selected content to be uploaded to the web resource. Step 806 processes the selected content using the accelerator that is selected. In one or more embodiments, an accelerator can present a preview of the selected content as the selected content can appear if the selected content were uploaded to a web resource. Additionally and/or alternatively, an accelerator can perform formatting or other procedures on the selected content so that the selected content is in a suitable form for a particular application and/or web resource. Step 808 uploads the selected content to a web resource. For example, the selected content can be uploaded to a web host to be published as part of a website, a blog, and/or any other suitable network-based entity.

Having discussed example methods according to one or more embodiments, consider now a discussion of an example system that can be utilized to implement the above-described embodiments.

Example System

FIG. 9 illustrates an example computing device 900 that can implement the various embodiments described above. Computing device 900 can be, for example, computing device 102 of FIG. 1 or any other suitable computing device.

Computing device 900 includes one or more processors or processing units 902, one or more memory and/or storage components 904, one or more input/output (I/O) devices 906, and a bus 908 that allows the various components and devices to communicate with one another. Bus 908 represents one or more of any of several types of bus structures, including a memory bus or memory controller, a peripheral bus, an accelerated graphics port, and a processor or local bus using any of a variety of bus architectures. Bus 908 can include wired and/or wireless buses.

Memory/storage component 904 represents one or more computer storage media. Component 904 can include volatile media (such as random access memory (RAM)) and/or nonvolatile media (such as read only memory (ROM), Flash memory, optical disks, magnetic disks, and so forth). Component 904 can include fixed media (e.g., RAM, ROM, a fixed hard drive, etc.) as well as removable media (e.g., a Flash memory drive, a removable hard drive, an optical disk, and so forth).

One or more input/output devices 906 allow a user to enter commands and information to computing device 900, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Conclusion

Various embodiments can provide a convenient way of sending selected online content to one or more applications, such as an application running on a local machine, a web application, a web service, and so on. In at least some embodiments, one or more accelerators can be presented to a user based at least in part on a user having selected content and the nature of the content that the user has selected. An accelerator can serve as a pipeline that can send the selected content to one or more applications. A variety of different accelerators can be utilized, and each accelerator can be suited to handle a particular type or types of content. A user can select a particular accelerator, which can cause an application associated with the accelerator to be launched and selected content to be provided to the application.

Although the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter.

What is claimed is:

1. A computer-implemented method comprising:
submitting information about selected content to one or more accelerators, the selected content being selected from a web resource and the one or more accelerators being configured to send the selected content to an application that is executable on a local computing device to process the selected content;
receiving relevance information from one or more of the accelerators; and
causing a notification that one or more of the accelerators are available to process the selected content to be presented on the local computing device, the notification being configured based at least in part on the relevance information.

2. The computer-implemented method of claim 1, wherein said submitting is performed responsive to a user selection of the selected content.

3. The computer-implemented method of claim 1, wherein one or more of the accelerators are configured to present a preview of the selected content on the local computing device, the preview comprising an indication of how the selected content can appear if the selected content were sent to the application.

4. The computer-implemented method of claim 3, wherein the one or more of the accelerators are configured to present the preview of the selected content responsive to a cursor hovering over an accelerator icon.

5. The computer-implemented method of claim 1, wherein one or more of the accelerators are configured to launch the application and send the selected content to the application responsive to a selection of an accelerator.

6. The computer-implemented method of claim 1, wherein the information about the selected content comprises metadata associated with the selected content.

7. The computer-implemented method of claim 1, wherein the information about the selected content comprises a file format of the selected content.

8. The computer-implemented method of claim 1, wherein the relevance information comprises an indication that the selected content is in a format that the application is configured to handle.

9. The computer-implemented method of claim 1, wherein the relevance information comprises a relevance value, and wherein the relevance value is determined by inspecting the selected content based on a plurality of relevance factors.

10. The computer-implemented method of claim 1, further comprising:
receiving a selection of one of the one or more accelerators; and
launching the application and sending the selected content to the application responsive to selection of the one of the one or more accelerators.

11. A computer-implemented method comprising:
receiving selected content that is selected from a network resource via a computing device;
presenting on the computing device a notification of one or more accelerators that are available to handle the selected content; and
causing an application to be launched on the computing device and the selected content to be sent to the application responsive to a selection of an accelerator of the one or more accelerators.

12. The computer-implemented method of claim 11, wherein the selected content is selected from a web browser user interface.

13. The computer-implemented method of claim 11, wherein said presenting comprises presenting a preview of the selected content, the preview comprising an indication of how the selected content can appear if the selected content were sent to the application.

14. The computer-implemented method of claim 11, wherein the notification is configured based at least in part on one or more relevance values assigned by one or more of the accelerators to the selected content.

15. The computer-implemented method of claim 14, wherein the one or more relevance values are determined based at least in part on the content type of the selected content.

16. The computer-implemented method of claim 14, wherein the selected content includes markup, and wherein the one or more relevance values for the selected content are determined based at least in part on the content of the markup.

17. The computer-implemented method of claim 11, wherein the notification is configured based at least in part on relevance values for each of a plurality of the accelerators, and wherein accelerator icons for each of the plurality of accelerators are arranged in the notification in order of descending relevance values.

18. One or more computer-readable storage media comprising computer-executable instructions which are executable to implement a system comprising:
an accelerator that is configured to:
receive selected content that is selected from an online resource via a web browser;
evaluate the selected content for relevancy using a plurality of relevancy factors associated with the accelerator;
cause a preview of the selected content to be presented, the preview comprising an indication of how the selected content can appear if the selected content were sent to an application; and
cause the application to be launched and the selected content to be provided to the application responsive to a selection of the accelerator.

19. The one or more computer-readable storage media of claim 18, wherein the system further comprises a web browser configured to submit the selected content to the accelerator.

20. The one or more computer-readable storage media of claim 19, wherein the system further comprises a plurality of accelerators.
